(19) United States
(12) Patent Application Publication
(10) Pub. No.: US 2015/0302716 A1
(43) Pub. Date: Oct. 22, 2015

(54) PROXIMITY ALERT SYSTEM AND APPLICATION

(71) Applicant: Lorraine Portalise, Parsippany, NJ (US)

(72) Inventor: Lorraine Portalise, Parsippany, NJ (US)

(21) Appl. No.: 14/256,024

(22) Filed: Apr. 18, 2014

(51) Int. Cl. G08B 21/02

(52) U.S. Cl. CPC G08B 21/0269

(57) ABSTRACT

A proximity alert application including: a receiver; at least one transmitter, where the at least one transmitter transmits a signal to the receiver; a pre-set distance correlated to a signal strength between the at least one transmitter and the receiver; an audio speaker on the receiver; an audio alert transmitted from the audio speaker upon breach of the pre-set distance between the receiver and at least one transmitter; a network signal transmitted from the receiver to at least one of a portable electronic device and a computer upon breach of the pre-set distance between the receiver and at least one transmitter; and a software application residing on the at least one portable electronic device and computer, where the software application receives and interprets the network signal from the receiver.

### BACKGROUND OF THE INVENTION

1. Field of Invention

The present invention relates to a proximity alert system and application that's integrated into a handheld or other electronic device.

2. Description of Related Art

Many times individuals must be reminded of a location or proximity of their loved ones such as infants, older adults or even pets. Generally a caretaker such as a parent must keep their eye on a child both inside the home and outside the home. More critically outside the home a parent must maintain site and location of their children at all times. Further in another example a caretaker of an older adult must also remain aware of the adult's whereabouts especially if the older adult has reduced capacity due to illnesses such as dementia. In another critical application, a pet owner must also maintain an idea of their pet's location when outdoors or in a park area. Presently there are limited options that provide electronic assistance to alert a parent of the proximity of a child or an older adult. Consequently it would be advantageous to have such an electronic alerting system integrated within a smart phone or other portable electronic device due to the prevalent use of such devices in the general consumer market.

### SUMMARY OF THE INVENTION

The present invention relates to a proximity alert application including: a receiver; at least one transmitter, where the at least one transmitter transmits a signal to the receiver; a pre-set distance correlated to a signal strength between the at least one transmitter and the receiver; an audio speaker on the receiver; an audio alert transmitted from the audio speaker upon breach of the pre-set distance between the receiver and at least one transmitter; a network signal transmitted from the receiver to at least one of a portable electronic device and a computer upon breach of the pre-set distance between the receiver and at least one transmitter; and a software application residing on the at least one portable electronic device and computer, where the software application receives and interprets the network signal from the receiver. The portable electronic device may include at least one of a smart phone and a tablet. The network signal may includes a GPS signal identifying the location of the receiver and the at least one transmitter.

### BRIEF DESCRIPTION OF DRAWINGS

FIG. 1 depicts components of a proximity alert system application in accordance with the present invention.

### DETAILED DESCRIPTION

The present invention relates to a proximity alert system application as a means to alert a parent, caretaker or a pet owner of the proximity of a child, older adult or a pet. Although the present invention may be used on particular objects it would most advantageously be used in the caretaking of a child or an older adult. The present system includes a mobile application that is integrated within a portable electronic device such as a smart phone, tablet or laptop computer. The integration of the application in the portable device includes an alerting system, where a user receives an electronic alert of a proximity breach of a child or older adult. During application signals may be sent from a transmitter to the alerting application and audible alerts may be transmitted from the transmitter providing a direct alarm of a proximity violation. In general, a transmitter is placed on a child, older adult or pet in the form of a necklace, wristband or other means of attachment. The transmitter sends a constant signal to a receiver that may be placed on a key chain in one particular embodiment. A pre-set distance is provided for the system to alert the user of a proximity violation. This distance may range within a few feet to a few yards between the transmitter and the receiver. Upon violation of the proximity, an audible alarm is activated on the receiver and further a GPS signal is sent via a network communication system such as a cellular network system to provide an additional alert to the application within a smart phone, tablet or other portable electronic device.

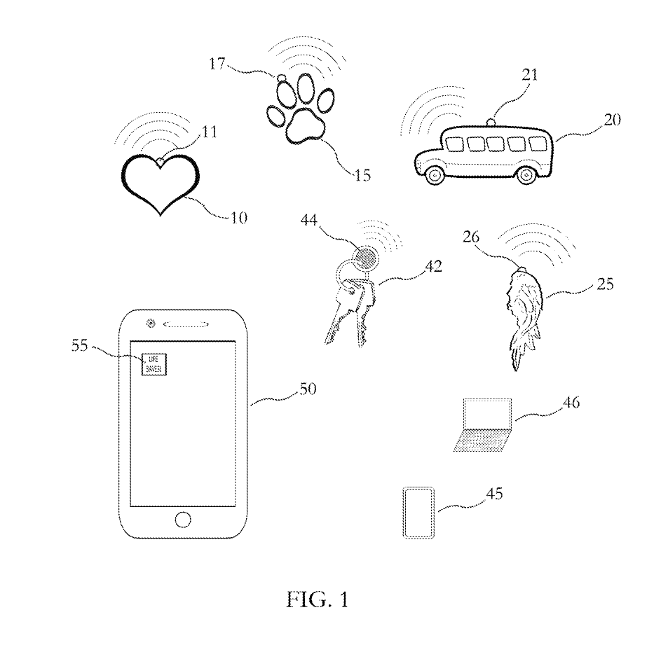

In reference to FIG. 1, the overall components of the proximity alert system are depicted. As shown in FIG. 1, a smart phone 50 may include an application 55 installed therein. Alternatively this application may be installed within a tablet 45 or a laptop computer 46. This application 55 receives signals via a common communication network currently available such as a cellular communication networks and an internet Wi-Fi connection that may be provided for the laptop computer 46. These signals relate to the alarms related to proximity alert that may go off in relation to the devices depicted in FIG. 1.

Examples of transmitters are shown in FIG. 1. These transmitters may be decorative pieces that are placed on a necklace or bracelet worn by a child, an older adult or pet. Transmitter 10 as depicted as a heart shape transmitter transmits constant signals through an antenna 11. Other examples of transmitters include a paw shaped transmitter 15 with antenna 17, an angel wing shaped transmitter 25 with antenna 26 and a bus shaped transmitter 20 with antenna 21. Any of these transmitters may be securely fixed to a child, older adult or a pet. A receiver 44 as shown on a key ring 42 receives signals from any one of the transmitters as depicted. The reception is based upon signal strength between the transmitter and the receiver, where a RF signal other type of signaling may be used. Signal strength would be based upon the distance between the transmitter and receiver and upon diminished signal strength indicating, as correlated with the distance between the transmitter and receiver, an audible alert may emit through the receiver 44. In addition to an audio alert, an activation alert may be sent via a cellular communication system. This signal may be sent through the cellular communication system and received by the smart phone 50 via the application 55. As a consequence, a user would receive both audio signals and a notice via a cellular phone application of a proximity violation. The proximity violation may also be broadcast to a handheld tablet 45 or via the laptop computer 46 as shown in FIG. 1.

The present invention preferably provides two means of alerting based upon proximity violation. Such a system therefore ensures that a caretaker receives an alert of the proximity breach of a child, older adult or pet as needed. Use of the present invention avoids situations, where a child may be left alone in a vehicle or an older adult may wander away from the property without knowledge of the caretaker. Further pets may be easily located through this alerting system. In addition, a GPS system is provided within the application providing pinpoint location of the transmitter and receiver that operate within the system. Such a system therefore is designed to provide notifications in a dual capacity to avoid any accidents or missing children, older adults or pets. The instant invention has been shown and described in what it considers to be the most practical and preferred embodiments. It is recognized, however, that departures may be made there from within the scope of the invention and that obvious modifications will occur to a person skilled in the art.

What is claimed is:

1. A proximity alert application comprising:
a. a receiver;
b. at least one transmitter, where the at least one transmitter transmits a signal to the receiver;
c. a pre-set distance correlated to a signal strength between the at least one transmitter and the receiver;
d. an audio speaker on the receiver;
e. an audio alert transmitted from the audio speaker upon breach of the pre-set distance between the receiver and at least one transmitter;
f. a network signal transmitted from the receiver to at least one of a portable electronic device and a computer upon breach of the pre-set distance between the receiver and at least one transmitter; and
g. a software application residing on the at least one portable electronic device and computer, where the software application receives and interprets the network signal from the receiver.

2. The proximity alert application according to claim 1, where portable electronic device includes at least one of a smart phone and a tablet.

3. The proximity alert application according to claim 1, where the network signal includes a GPS signal identifying location of the receiver and the at least one transmitter.

4. The proximity alert application according to claim 1, where signal to the receiver includes a RF signal.

5. The proximity alert application according to claim 1, where the at least one transmitter includes a unique design.

6. The proximity alert application according to claim 5, where the unique design includes a heart shape, a paw shape or a school bus image.
